(19) United States
(12) Patent Application Publication
(10) Pub. No.: US 2009/0156771 A1
(43) Pub. Date: Jun. 18, 2009

(54) Amine-Containing Compounds for Enhancing the Activity of ATRP Catalysts and Removal of the Terminal Halogen Groups from the ATRP Polymer Products

(76) Inventors: Youqing Shen, Laramie, WY (US); Huadong Tang, Laramie, WY (US); Maciej Radosz, Laramie, WY (US)

Correspondence Address: DAVIS, BROWN, KOEHN, SHORS & ROBERTS, P.C.;THE DAVIS BROWN TOWER, 215 10TH STREET SUITE 1300, DES MOINES, IA, 50309, US

(21) Appl. No.: 11/958,336

(22) Filed: Dec. 17, 2007

(51) Int. Cl. C08F 8/26; C07F 1/08

(52) U.S. Cl. 526/319; 556/110; 526/346

(57) ABSTRACT

Disclosed are new, highly active and versatile atom transfer radical polymerization (ATRP) catalysts. These catalysts catalyze ATRP for acrylates, methacrylates, and styrenes at surprisingly low concentrations. These catalysts mediated ATRP at a catalyst/initiator molar ratio at 0.005 and produced polymers with well-controlled molecular weights and low polydispersities. ATRP occurred even at a catalyst/initiator molar ratio as low as 0.001 with metal concentration in the produced polymers as low as 6-8 ppm. Amine-containing compounds, such as triethylamine, can significantly increase the catalyst activity of theses catalysts. The amine compounds can also used to the terminal halogen groups such as Br and Cl in the polymers prepared by ATRP.

This application claims priority to U.S. Patent Application Ser. No. 60/874,767, filed Dec. 15, 2006, and incorporated herein by this reference.

### BACKGROUND OF THE PRIOR ART

The present application relates generally to polymerization catalysts and, more specifically, to active and versatile catalysts for the atom transfer radical polymerization of monomers.

Atom transfer radical polymerization (ATRP) is a transition metal complex-mediated “control/living” radical polymerization. It has been used for a wide range of vinyl monomers to prepare not only homopolymers but also well-defined random, gradient, block, branch, and star (co)polymer structures. ATRP is catalyzed by transition-metal complexes, such as copper, iron, molybdenum, osmium and ruthenium that mediate a fast and dynamic equilibrium between the dormant and active polymer chains (FIG. 1). The transition metal complex catalyst plays a crucial role in establishing the dynamic activation/deactivation equilibrium between the dormant and live radical species to control the polymerization. A successful ATRP requires both the activation rate constant k_{act} and the deactivation rate constant k_{deact} to be large enough to establish a fast activation/deactivation equilibrium, but k_{act} should be much smaller than k_{deact} (k_{act}<<k_{deact}) to maintain a good control over the polymerization The equilibrium constant K_{ATRP} (K_{ATRP}=k_{act}/k_{deact}) determines the activity of a catalyst and the polymerization rate. A larger equilibrium constant leads to a higher catalyst activity and a higher polymerization rate. For most ATRP catalysts, a catalyst concentration ranging from 1000 to 20,000 ppm (i.e., catalyst/initiator molar ratio of 0.1 to 1 or catalyst/monomer molar ratio of 0.001 to 0.02) is generally needed to provide a controlled polymerization with a reasonable polymerization rate. These catalysts co-precipitate with the polymer products after polymerization, coloring and contaminating the products. Thus, high catalyst loading not only increases the polymerization cost but also requires the post-polymerization removal of the catalyst residue in obtained polymers.

It has been reported that the addition of zerovalent metal such as copper(0) can significantly increase the polymerization rate due to the formation of active copper(I) catalyst by reduction of copper(II) with copper(0) (K. Matyjaszewski, S. Coca, S. G. Gaynor, M. Wei, B. E. Woodworth, Macromolecules 1997, 30, 7348) and thus the polymerization could be carried out with a reduced amount of catalyst.

Copper (I) halides ligated with polydentate amines are widely used as ATRP catalysts due to their availability, versatility and low cost. The ligands play an important role in the catalytic activity. Tetradentate branched ligands form highly active catalysts such as CuBr/tris[2-(N,N-dimethylamino)ethyl]amine (Me₆TREN) and CuBr/tris(2-pyridylmethyl)-amine (TPMA) (Xia, J.; Matyjaszewski, K. Macromolecules 1998, 31, 5958; b) Xia, J.; Matyjaszewski, K. Macromolecules 1999, 32, 2434; c) Inoue, Y.; Matyjaszewski, K. Macromolecules 2004, 37, 4014). While for most catalysts a catalyst/initiator molar ratio (Cu/I) of 1/1 is used, CuBr/Me₆TREN catalyzed polymerizations of methyl acrylate (MA) and butyl acrylate (BA) in a well-controlled manner at a Cu/I of 0.1. The complex also catalyzed a well-controlled ATRP of styrene (St) at a Cu/I of 0.5, but the polymerization at Cu/I of 0.1 only reached a low conversion and the resulting polystyrene had a high polydispersity index (PDI >1.5). This catalyst failed to polymerize methyl methacrylate (MMA) at low catalyst concentrations. CuBr/TPMA mediated well-controlled polymerizations of MA and St at a Cu/I of 0.2 (Xia, et al., 2004). It was also reported that CuBr/N-tetramethyltriaminephenoxide (Me₄TAPH) catalyzed the polymerization of BA at a Cu/I of 0.05 (Xia, et al., 2004). Faucher and Zhu reported that CuBr/1,1,4,7,10,10-hexamethyltriethylenetetramine (HMTETA) polymerized MMA to a low conversion in a controlled/“living” manner at a Cu/I of 0.01 (Faucher, S.; Zhu, S. Ind. Eng. Chem. Res. 2005, 44, 677). These catalysts, however, could not catalyze “living” polymerizations of MA and St at low catalyst concentrations (e.g. Cu/I=0.1 and 0.01).

### SUMMARY OF THE INVENTION

The present invention consists of new, highly active and versatile ATRP catalysts. These catalysts catalyze ATRP for methyl acrylate (MA), methyl methacrylate (MMA), and styrene at surprisingly low levels. These catalysts mediated ATRP at a catalyst/initiator molar ratio at 0.005 and produced polymers with well-controlled molecular weights and low polydispersities. ATRP occurred even at a catalyst/initiator molar ratio as low as 0.001 with metal concentration in the produced polymers as low as 6-8 ppm.

In the MMA and styrene polymerizations, tertiary amines, such as triethylamine (TEA) and N,N,N′,N′-tetrakis(2-pyridylmethyl)ethylenediamine (TPEN) were found to further improve the catalyst activity. In addition, the current catalyst system mediates activator-generated-by-electron-transfer (AGET) ATRP. The AGET ATRP shows not only high catalytic activity but is also versatile for acrylate, methacrylate and styrenic monomers. Further, unlike tin-based reducing agents of the prior art, the tertiaryamine-based reducing agents are volatile and do not leave contaminants in the resulting polymers. The amine-containing compounds are also useful for removing halogen groups from polymers synthesized using transition-metal catalyzed radical polymerization.

### BRIEF DESCRIPTION OF THE DRAWINGS

FIG. 1 is a diagrammatic representation of a scheme of ATRP.

FIG. 2 is a kinetic plot for ATRPs of methyl acrylate (MA) with the addition of tertiary amine; conditions: 80° C.; [MA]=10.8 M, [MBP]=0.108 M, [CuBr]=1.08 mM; (▴) [Me₆TREN]=55.0 mM; (▾) [Me₆TREN]=11.0 mM; (♦) [TEA]=97.0 mM, [Me₆TREN]=1.08 mM; (▪) [Me₆TREN]=1.08 mM.

FIG. 3 is a kinetic plot for ATRPs of MA without the addition of tertiary amine under the same conditions as recited for FIG. 2.

FIG. 4 is a plot of the dependence of M_{n,SEC} and M_{w}/Mₙ on monomer conversion for the ATRP of MA with and without addition of tertiary amine under the same conditions as recited for FIG. 2.

FIG. 5 is a kinetic plot of the normal (▪) and AGET (♦) ATRP of MA; conditions: 80° C., [MA]=10.8 M, [EBiB]=0.108 M; Normal ATRP: [CuBr]=[TPEN]=1.08 mM; AGET ATRP: [CuBr₂]=[TPEN]=1.08 mM; [TEA]=0.108 M.

FIG. 6 is a chart of the dependence of M_{n,SEC} and M_{w}/Mₙ of PMA on monomer conversion for the normal (▪) and AGET (♦) ATRP of MA under the conditions of FIG. 5.

FIG. 7 is a chart of PS, PMA and PMMA prepared by AGET ATRP; conditions: [St]=8.7 M, 100° C., St/EBiB/CuBr2/TPEN=100:1:0.01:0.01, [TBA]=0.087M; [MA]=10.8M, 80° C., MA/EBiB/CuBr2/TPEN=100:1:0.01:0.01, [TEA]=0.108 M; [MMA]=9.2 M, 80° C., MMA/EBiB/CuBr2/TPEN=100:1:0.01:0.01, [TEA]=0.092 M.

FIG. 8a is a chart of kinetic plots for ATRP of MA catalyzed by CuBr/TPEN, CuBr/Me₆TREN and CuBr/TPMA. 80° C., [MA]=10.8 M, [EBiB]=0.108 M, Cu/I (i.e., CuBr/EBiB)=0.1, 0.01, 0.005 and 0.001, and FIG. 8b is a chart of the plots of conversion and ln([M]₀/[M]) versus time, where [M] is the monomer concentration and [M]₀ is the initial monomer concentration.

FIG. 9a is a chart of GPC evolution curves during the polymerization of MA at Cu/I=0.005, and FIG. 9b is a chart of PMA number-average molecular weight (Mₙ) and its PDI (M_{w}/Mₙ) as a function of monomer conversions for the ATRP of MA catalyzed by CuBr/TPEN at Cu/I=0.1 (▪,□), 0.01 (,◯), 0.005 (▾,∇) and 0.001 (♦,⋄); conditions are as in FIG. 9.

FIG. 10a is a chart of the conversion (solid symbols) and ln [M]₀/[M] (hollow symbols) versus time plots for ATRP of St (♦,⋄) and MMA (▪,□), and FIG. 10b is a chart of the molecular weight (Mₙ, solid symbols) and polydispersity (M_{w}/Mₙ, hollow symbols) as a function of conversion for ATRP of St (♦,⋄) and MMA (▪,□) catalyzed by CuBr/TPEN at Cu/I=0.005. St polymerization: 100° C., [St]=8.7 M, [EBiB]=0.087 M, [TBA]=0.049 M, [CuBr]=[TPEN]=0.435 mM; MMA polymerization: 80° C., [MMA]=9.2 M, [EBiB]=0.092 M, [TEA]=0.091 M, [CuBr]=[TPEN]=0.46 mM.

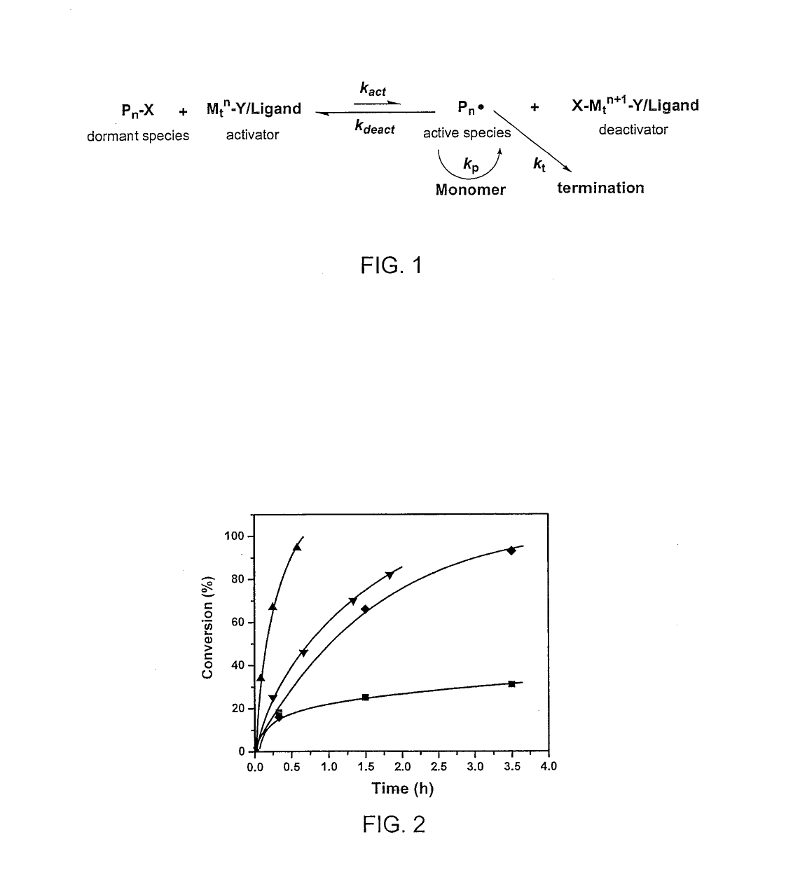

### DETAILED DESCRIPTION OF PREFERRED EMBODIMENTS

The present invention provides a catalyst composition for living free radical polymerization. Using the catalyst composition of the present invention, a monomer can undergo homopolymerization or copolymerization in the presence of a compound capable of generating free radicals through living free radical polymerization. Polymers with narrow polydispersity can be obtained.

The catalyst composition of the present invention includes a transition metal and a ligand. The catalyst composition of the present invention can be used to polymerize at least one monomer of methyl acrylate (MA), methyl methacrylate (MMA), and styrene monomers. In the presence of a compound capable of generating free radicals, one or more monomers as mentioned above, is contacted with a catalytically effective amount of the catalyst composition to undergo homopolymerization or copolymerization. Various conventional polymerization methods such as emulsion, bulk, suspension, and solution polymerization can be used. Moreover, using the catalyst composition of the present invention to catalyze the polymerization of methyl acrylate, methyl methacrylate, and styrene, a polymer with narrow polydispersity (PDI) is obtained, and the PDI can be as small as 1.05 and typically range between 1.1 and 1.4.

Using the catalyst composition of the present invention, the polymer obtained can be a homopolymer or a copolymer. Various copolymers with a well-defined structure can be obtained, including (1) “pure” block copolymers (two or more blocks) with narrow polydispersity, (2) graft copolymers with narrow polydispersity, (3) gradient copolymers, (4) star copolymers, and (5) hyperbranched copolymers. Various polymers with a terminal functional group can also be prepared. The emergence of various novel polymers can provide new materials with novel properties, or enhance the performance of existing products. The polymer materials developed in the present invention can be applied in many fields, including optical fiber, dispersants such as pigment dispersants in ink, photoresists, surfactants, surface treating agents, detergents, adhesives, rheology controllers, coatings, and thermoplastic elastomers.

A transition metal as used in this application refers to scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, and mercury. Halide(s) refers to a compound including a halogen atom consisting of fluorine, chlorine, bromine, iodine and astatine.

As used herein, tertiary amines are amines with three moieties other than hydrogen bonded to the nitrogen atom and include triethylamine (TEA), tripropylamine (TPA), N,N,N′,N′-tetrakis(2-pyridylmethyl)ethylenediamine (TPEN), tributylamine (TBA), pyridine Me₆TREN, TPMA, HMTETA, methyldiethanolamine (MDEA), triethanolamine, dimethylethanolamine (DMEA), N,N,N′,N′-tetramethylethylenediamine, and N,N,N′,N′-tetraethylethylenediamine.

Monomers that may be polymerized using the catalysts systems of the present invention include, but are not limited to, methyl acrylate, ethyl acrylate, butyl acrylate, methyl methacrylate, ethyl methacrylate, butyl methacrylate, styrene, and 4-methyl styrene.

The amount of catalysts of the present invention needed to mediate ATRP is between 10⁻⁸ mol % and 10⁻¹ mol % of the used monomer, and any amount in that range, including 10⁻⁷, 10⁻⁶, 10⁻⁵, 10⁻⁴, 10⁻³, and 10⁻².

The amount of tertiary amines useful in improving catalytic activity in the present invention is between 10⁻⁵ mol % and 10⁻¹ mol % of the used monomer, and any amount in that range, including 10⁻⁴, 10⁻³, and 10⁻².

The amount of initiator needed in the present invention is between 10⁻³ mol % and 10⁻¹ mol % of the used monomer, and any amount in that range, including 10⁻².

### Example 1

### ATRP Catalyzed by CuBr/Me₆TREN with Addition of Tertiary Amine

A typical polymerization procedure of MA for catalyst-to-initiator ratio of 0.01 was as follows. CuBr (2.87 mg, 0.02 mmol) and a stirring bar were charged into a Schlenk flask and the flask was tightly sealed with a rubber septum. The flask was degassed by applying high vacuum and back-filling with argon (3 cycles). Degassed MA (18.5 mL, 0.2 mol), Me₆TREN (5.5 μL, 0.02 mmol) and TEA (0.25 mL, 1.8 mmol) were then added through a stainless needle under the protection of argon. After the reaction flask equilibrated to 80° C. in an oil bath, the argon-purged initiator MBP (0.24 mL, 2.0 mmol) was added via a degassed syringe. At timed intervals, samples were withdrawn via a degassed gastight syringe and stored in refrigerator for NMR and gel permeation chromatography (GPC) measurements.

Removal of the terminal halogen ligand: After the polymerization was complete in the above reaction, an additional 2.0 ml of TEA was added and the mixture was stirred 80° C. for 24 h. The terminal halogen group content was analyzed.

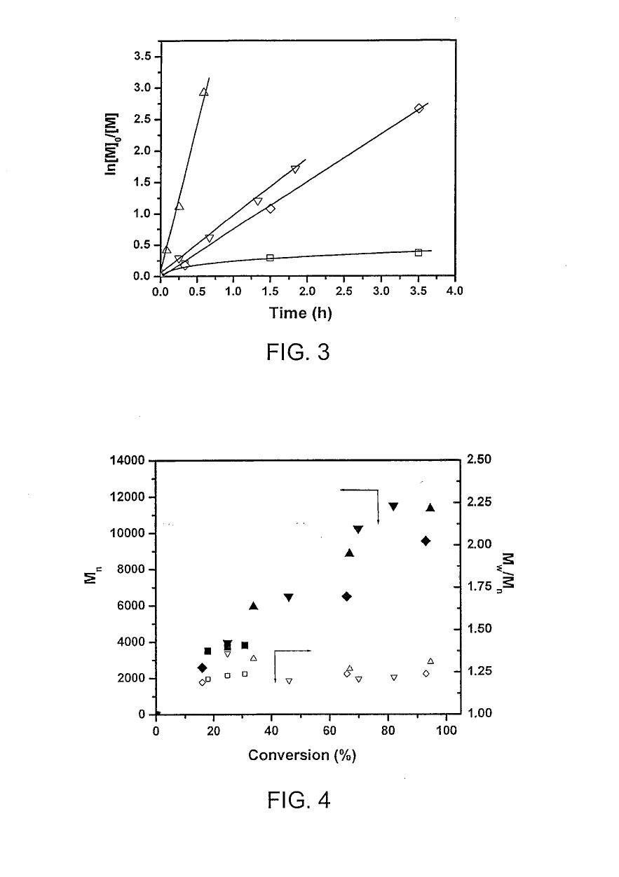

FIG. 2 shows the kinetic results of ATRP of MA at 80° C. with the addition of tertiary amine and FIG. 3 shows the kinetic results without the addition of a tertiary amine. Methyl 2-bromopropionate (MBP) was used as initiator and the catalyst concentration was 1 mol % relative to the initiator.

The polymerization catalyzed by CuBr/Me₆TREN (1/1 molar ratio) without the addition of a tertiary amine was slow, and only reached about 35% conversion and then leveled off, producing PMA with low molecular weight. A significant rate enhancement was observed when a tertiary amine such TEA or Me₆TREN ligand itself was added to the system. The polymerization reached 95% conversion in 3.5 h in the presence of 0.097 M TEA (TEA/CuBr molar ratio of 90). The rate was increased even more remarkably when an excess of Me₆TREN was added. For example, the polymerization with Me₆TREN in a ratio of about 10 times of CuBr reached 80% conversion in 100 min. With Me₆TREN/CuBr˜50 ([Me₆TREN]=0.055 M), the polymerization was so fast that it reached almost 100% conversion in half hour. The ln [M]₀/[M] versus time plots of the polymerization in the presence of TEA or an excess of Me₆TREN were linear and passed the origin, indicating the concentration of growing radicals remained constant. A plot of the dependence of M_{n,SEC} and M_{w}/Mₙ on monomer conversion for the ATRP of MA with and without addition of tertiary amine is shown in FIG. 4.

The molecular weights of resulting PMA from the polymerization with Me₆TREN/CuBr of 1/1 were low and did not increase with the monomer conversion (FIG. 4). While the molecular weights of PMA from the polymerizations with addition of TEA or an excess of Me₆TREN were close to the theoretical value and increased linearly with monomer conversion. The polydispersity was less than 1.30, indicating living characters and good control of these polymerizations. Obviously, the addition of the tertiary amine caused significant increase in polymerization rate and activity of CuBr/Me₆TREN for the polymerization of MA. The catalyst concentration could be reduced by ten times (at 1 mol % relative to the initiator) without sacrificing the living character and control of the polymerization. Actually, with the addition of tertiary amine, MA could even be polymerized at 0.25 mol % catalyst relative to initiator. Under such a low catalyst concentration, without a tertiary amine, CuBr/Me₆TREN (1/1) cannot polymerize MA at all. While with the presence of a tertiary amine, approximately 0.05 M Me₆TREN, the polymerization of MA reached 90% conversion in 4.5 h. The molecular weights of the resulting PMA were higher than theoretical value and had a relative high polydispersity (about 1.5), but they did increase lineally with monomer conversion, indicating that the tertiary amine improved the catalyst activity so much that it even can work at 0.25 mol % catalyst concentration.

The effects of tertiary amine on the polymerizations of MMA and styrene were also tested. Table 1 summarizes the results of ATRPs of MMA and styrene with and without addition of a tertiary amine, using ethyl 2-bromo-isobutyrate (EBiB) as initiator.

TABLE 1
The effects of tertiary amine on the ATRPs of MMA and Styrene^{a}

| | [CuBr]/ | [Me₆TREN]/ | [TEA] or | time | conv | | | |
|---|---|---|---|---|---|---|---|---|
| entry | [EBiB] | CuBr | [TBA]/CuBr | (h) | (%) | M_{n,SEC} | M_{n,Cal} | PDI |
| St | 0.1 | 1 | 0 | 12 | 17 | 2700 | 1770 | 1.34 |
| St^{b} | 0.1 | 1 | 10 | 9 | 73 | 7700 | 7590 | 1.24 |
| St | 0.01 | 1 | 0 | 18 | <10 | — | — | — |
| St | 0.01 | 50 | 0 | 10.5 | 79 | 9400 | 8210 | 1.70 |
| St | 0.01 | 10 | 0 | 9 | 65 | 9900 | 6760 | 1.87 |
| MMA | 0.1 | 1 | 0 | 12 | 8 | 2200 | 800 | 2.80 |
| MMA^{c} | 0.1 | 1 | 10 | 9 | 87 | 31900 | 8700 | 1.42 |
| MMA | 0.01 | 1 | 0 | 14 | <5 | — | — | — |
| MMA | 0.01 | 50 | 0 | 5 | 81 | 44900 | 8100 | 1.51 |
| MMA | 0.01 | 10 | 0 | 9.5 | 63 | 37300 | 6300 | 1.38 |

^{a}All MMA bulk polymerizations were conducted at 80° C. and all St bulk polymerizations were conducted at 100° C., [MMA] = 9.2 M, [St] = 8.6 M, [MMA]:[EBiB] = 100:1, [St]:[EBiB] = 100:1
^{b}0.086 M TBA was added in the polymerization due to its high boiling point
^{c}0.092 M TEA was added in the polymerization.

CuBr/Me₆TREN (1/1) catalyzed styrene polymerization at 10 mol % catalyst relative the initiator ([CuBr]/[EBiB]=0.1) only reached 17% conversion in 12 h and produced polystyrene with low molecular weight. Under the same catalyst concentrations, the addition of tributylamine (TBA) (TBA/Cu molar ratio=10) could promote the polymerization to 73% conversion in 9 h, producing polystyrene with molecular weight close to theoretical value and low polydispersity. At 1 mol % catalyst relative to the initiator ([CuBr]/[EBiB]=0.01), CuBr/Me₆TREN (1/1) could not mediate living polymerization of styrene. The polymerization stopped at very low conversion (<10%) without the addition of a tertiary amine. While with an excess of Me₆TREN (Cu/Me₆TREN=50 or 10), styrene could be polymerized very well, producing polystyrenes with molecular weight close to theoretical value but relatively high polydispersity.

CuBr/Me₆TREN (1/1) could not polymerize MMA at 10 mol % catalyst versus initiator. The polymerization stopped at very low conversion (8%), producing low molecular weight PMMA with high polydispersity (PDI=2.8). The presence of TEA (1 mol % of MMA) substantially increased the polymerization rate. The polymerization reached 87% conversion in 9 h. With an excess of ME₆TREN (CuBr/Me₆TREN=50 or 10), the polymerization could proceed even at 1 mol % catalyst relative to the initiator. The polymerizations produced PMMA with relatively low polydispersity, indicating a living polymerization, but the PMMA molecular weights were much than their theoretical values (i.e., low initiation efficiency). This is agreeable with the previous reports in CuBr/Me₆TREN-catalyzed MMA polymerization (J. Queffelec, S. G. Gaynor, K. Matyjaszewski, Macromolecules 2000, 33, 8629).

The terminal halogen group can be removed by adding an additional amount of amine containing compounds such as triethylamine and diethylamine. In the example set out above, more than 90% of the terminal bromine groups were removed after 24 h stirring.

### Example 2

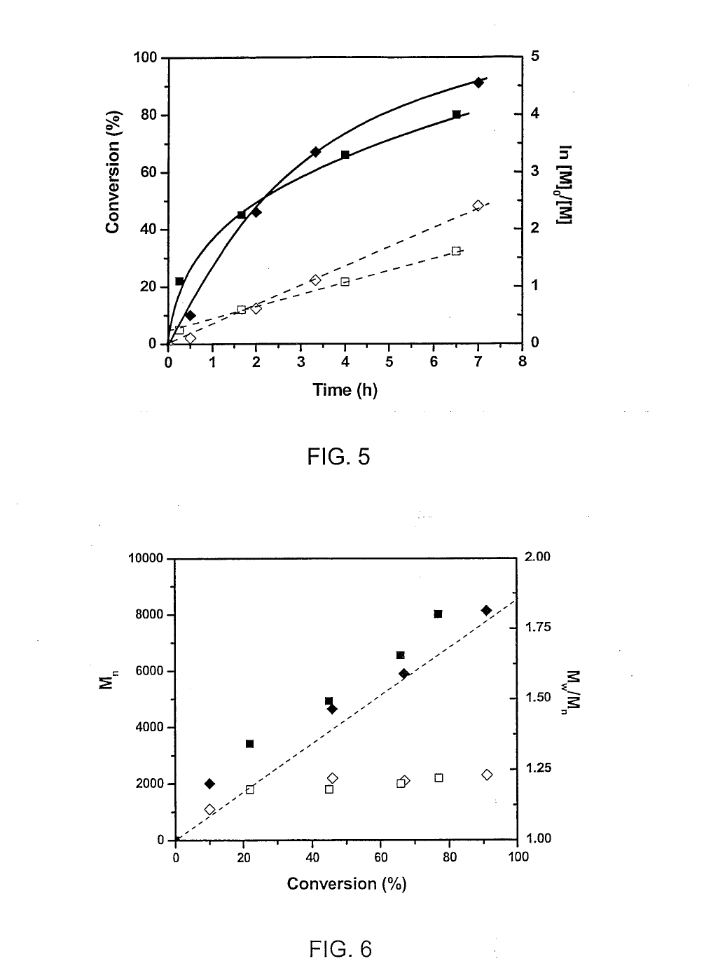

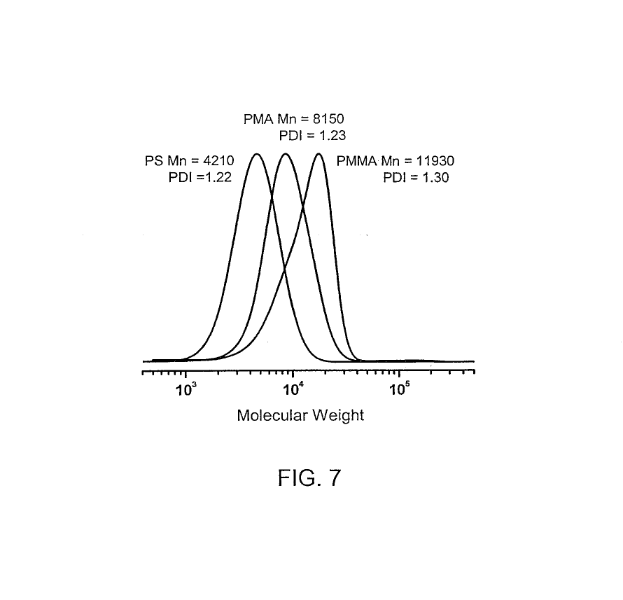

AGET ATRP with tertiary amine as reducing agent. A typical procedure for AGET ATRP of MA was as follows. TPEN (8.5 mg, 0.02 mmol), and CuBr₂ (4.47 mg, 0.02 mmol) were charged into a reaction tube. 0.1 mL γ-butyrolactone was added to dissolve the CuBr₂ and promote the formation of CuBr₂/TPEN complex. MA (18.5 mL, 0.2 mol) was then added and the tube was sealed with a rubber septum. The mixture was purged with argon for 20 minutes, and TEA (0.28 mL, 2.0 mmol) was added to the system through a syringe. After the reaction tube equilibrated to 80° C. in an oil bath, EBiB (0.30 mL, 2.0 mmol) was introduced via a degassed syringe. Samples were withdrawn at timed intervals using degassed syringes and stored in refrigerator for NMR and GPC measurements. Results are shown in FIGS. 5 and 6.

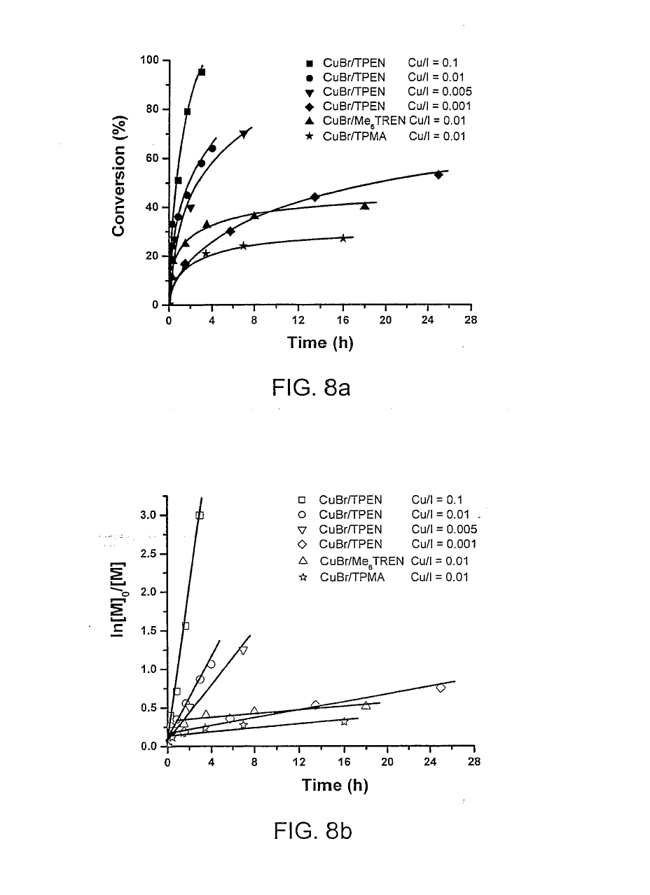

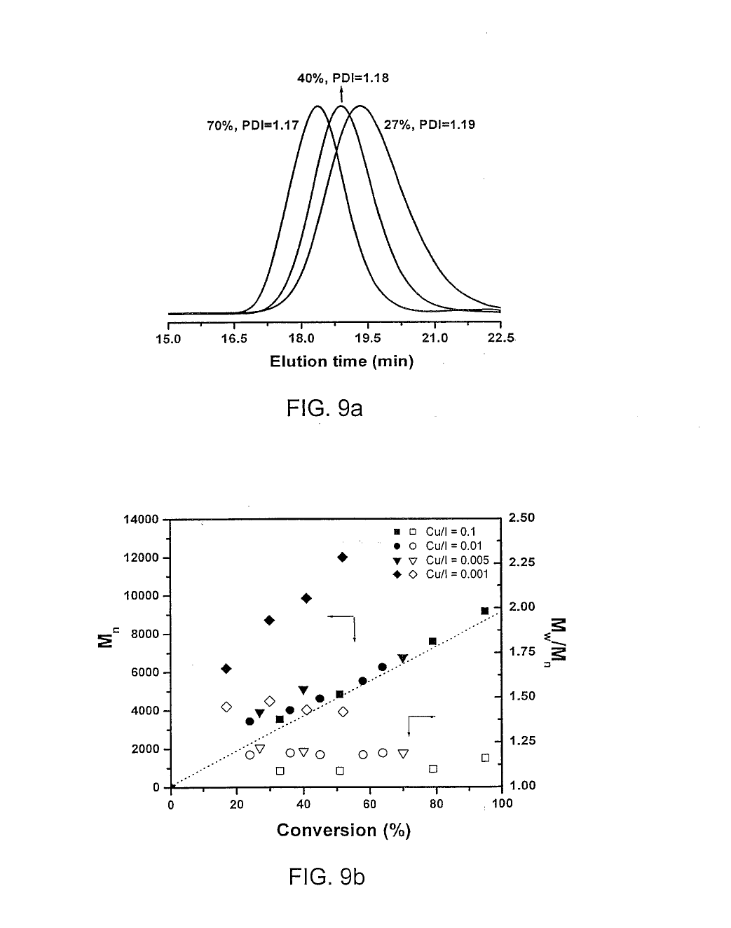

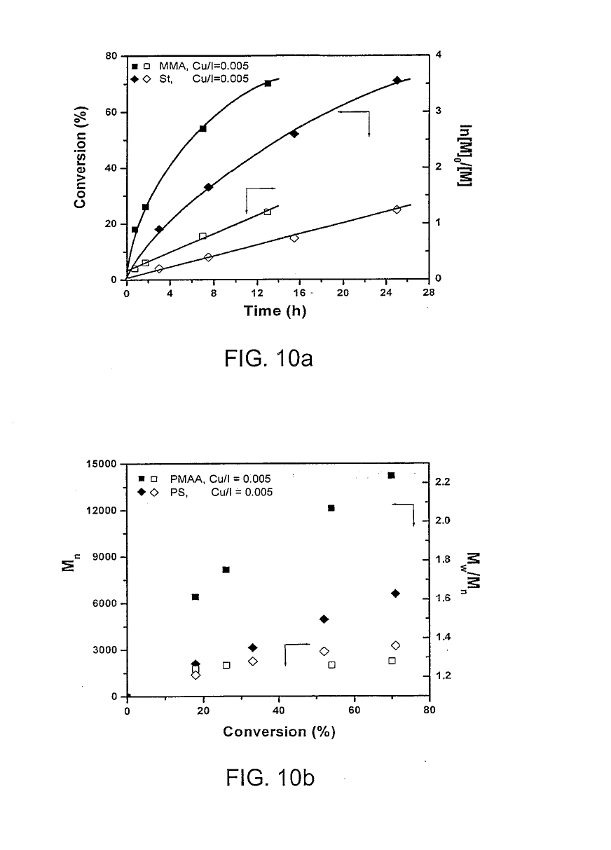

FIGS. 8-10 show the polymerization catalyzed by CuBr/TPEN. The polymers prepared with CuBr/TPEN at the Cu/I of 0.005 and lower are transparent and almost colorless. The catalyst concentrations are very low in these polymers. For example, the theoretical copper contents in PMMA are 31.5 ppm at Cu/I of 0.005, and 6.3 ppm at Cu/I of 0.001. The copper contents in the PMMA prepared at the Cu/I of 0.005 and 0.001, as measured by ICP-MS, were 33.7 ppm and 6.9 ppm, respectively. This may be low enough to eliminate the need for post-purification and catalyst recovery for most applications, which is a promising milestone toward a commercial ATRP at industrial scale with no need for the removal of catalyst residue.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention.

We claim:

1. An atom transfer radical polymerization catalyst, comprising a complex of a transition metal halide and a tertiary amine ligand.

2. The catalyst of claim 1, wherein the tertiary amine is selected from the group consisting of triethylamine (TEA), tripropylamine (TPA), N,N,N′,N′-tetrakis(2-pyridylmethyl)ethylenediamine (TPEN), tributylamine (TBA), pyridine Me₆TREN, TPMA, HMTETA, methyldiethanolamine (MDEA), triethanolamine, dimethylethanolamine (DMEA), N,N,N′,N′-tetramethylethylenediamine, and N,N,N′,N′-tetraethylethylenediamine.

3. A method for increasing the catalyst activity for transition-metal catalyzed radical polymerization, comprising the step of adding amine-containing compounds to the reaction system.

4. A method for removing halogen groups from a polymer synthesized using transition-metal catalyzed radical polymerization, comprising the step of reacting the polymer with amine-containing compounds.

5. The method of claim 3, wherein the transition metal halide is a copper chloride or bromide.

6. The method of claim 3, wherein the amine-containing compounds comprise tertiary amines.

7. The method of claim 6, wherein the tertiary amine is selected from the group consisting of triethylamine (TEA), tripropylamine (TPA), N,N,N′,N′-tetrakis(2-pyridylmethyl)ethylenediamine (TPEN), tributylamine (TBA), pyridine Me₆TREN, TPMA, HMTETA, methyldiethanolamine (MDEA), triethanolamine, dimethylethanolamine (DMEA), N,N,N′,N′-tetramethylethylenediamine, and N,N,N′,N′-tetraethylethylenediamine.

8. The method of claim 13, wherein the polymerization is of monomers selected from the group consisting of acrylates, methacrylates, and styrenes.

9. The method of claim 8, wherein the monomers are selected from the group consisting of methyl acrylate, ethyl acrylate, butyl acrylate, methyl methacrylate, ethyl methacrylate, butyl methacrylate, styrene, and 4-methyl styrene.
